(19) United States
(12) Patent Application Publication
(10) Pub. No.: US 2022/0020066 A1
(43) Pub. Date: Jan. 20, 2022

(54) CONTENT SERVER FOR MANAGING MEDIA DATA BETWEEN PUBLISHERS, THIRD-PARTY NETWORKS, AND A COMPUTING DEVICE

(71) Applicant: Apomaya, Inc., San Jose, CA (US)

(72) Inventors: Andrew Robinson, Morgan Hill, CA (US); Alexei Tumarkin, Los Altos Hills, CA (US)

(73) Assignee: Apomaya, Inc., San Jose, CA (US)

(21) Appl. No.: 16/816,170

(22) Filed: Mar. 11, 2020

Related U.S. Application Data
(60) Provisional application No. 62/817,996, filed on Mar. 13, 2019.

(51) Int. Cl. G06Q 30/02; G06F 16/958

(52) U.S. Cl. CPC G06Q 30/0277; G06F 16/958

(57) ABSTRACT

A content server for managing media data between one or more publishers, third-party networks, and a computing device is disclosed. The content server includes one or more processing units and a computer-readable media. The computer-readable media stores instructions that, when executed by the one or more processing units, cause the content server to perform operations that include receiving, as an intermediary, a request from the computing device for information content from a specific publisher of the one or more publishers; requesting the information content from the specific publisher, wherein the information content includes advertising-related content and/or non-advertising-related content; receiving, from the specific publisher, the information content within a first media data; detecting the advertising-related content and/or non-advertising-related content within the information content; modifying the advertising-related content and/or non-advertising-related content to produce a modified information content; producing and inserting an execution code into the modified information content to produce a second media data; serving the second media data to the computing device; receiving from the computing device a request for the advertising-related content and/or non-advertising-related content; requesting the advertising-related content and/or non-advertising-related content from the third-party network; receiving the advertising-related content and/or non-advertising-related content from the third-party network; modifying the advertising-related content and/or non-advertising-related content to produce a modified advertising-related content and/or non-advertising-related content; inserting the modified advertising-related content and/or non-advertising-related content into second media data to produce an updated second media data; and serving the updated second media data to the computing device in a manner where it may be accessed by the computing device when the execution code is invoked by an end user of the computing device.

### RELATED APPLICATIONS

This application claims priority to U.S. Provisional Patent Application Ser. No. 62/817,966, titled “Content Server For Managing Media Data Between Publishers, Third-Party Networks and A Computing Device,” filed on Mar. 13, 2019, which is herein incorporated by reference in its entirety.

### BACKGROUND

### 1. Field

The present disclosure is related to computing systems that communicate over a network, and more specifically, to computing systems that receive, modify, and transfer data over a network.

### 2. Related Art

With the penetration of the Internet and increasing popularity of digital platforms, digital advertising has grown to become one of the most important forms of advertising. Digital advertising revenue worldwide is forecast to increase at a fast pace in the coming years. More than 143 billion U.S. dollars were spent on digital advertising in 2014. By 2020, this figure is projected to increase to nearly 268 billion U.S. dollars.

The increase in digital advertising has been a financial boon for targeting advertisements to specific individual tastes, but it has also caused a hugely disruptive and annoying advertising experience for end users who believe that advertisements are more intrusive and prevalent today, are security concerns, and retargeting them through tracking techniques. Interestingly, most end users believe that not all advertisements are bad, but they are desirous of filtering out the advertisements they find particularly obnoxious. As such, most end users prefer ad filtering over complete ad blocking.

In addition to the experiences of end users, presently it is estimated that invalid Internet traffic costs the digital advertising industry billions per year because of both the direct effect of fraudulent parties and the estimated millions spent to fight and address this invalid traffic. Moreover, it is projected that an additional billion was lost to “malvertising,” which includes practices such as hijacking an browsers of end users or illegally downloading viruses and software onto the machines of the end users for the purpose of generating botnets and other deceptive tactics, including link hijacking in which fraudsters replace a legitimate link with their own ad injection where illegitimate advertisements are inserted onto legitimate publishers' sites without their knowledge.

These problems have resulted in a strong growth of the use of ad blockers by many end user. For end users, ad blocking has become a way to regain control. Unfortunately, these ad blockers cost digital publishers billions in lost revenue.

At present, websites today only have a few options to address the effects of ad blocking on their business: a) measure the ad blocking impact and provide mechanisms to re-insert advertisements, for example, PageFair; b) pay to be a part of a whitelist of the respective Ad Blockers to display ‘acceptable ads’; c) implement IAB recommended LEAN and DEAL programs or a similar variation.

Moreover, in the current landscape of the digital advertising ecosystem, there are a multitude of players, such as networks, advertising exchanges providing real time bidding services, supply side providers representing publishers, demand side providers representing advertisers and many others, who work together to fill specific advertising slots on a web page. The primary mechanism to participate in this advertising delivery system is via injection of JavaScripts to the publisher's content to be executed on the browsers of end users.

Unfortunately, adding such new code to a site naturally risks increasing page latency that directly affects the satisfaction and experience of the end user. Integrating multiple partners creates more work, more resource, and more latency, so it is worse for the experience of the end user. As such, the detrimental impact of advertising delivery to an experience of an end user creates a need for a system and method that provides significantly reduced latency for advertising serving, protects end users against malvertising and/or provides guarantees of content integrity according to the preferences of the publishers and the end users.

### SUMMARY

Disclosed is a content server for managing media data between one or more publishers, third-party networks, and a computing device. The content server includes one or more processing units and a computer-readable media. The computer-readable media stores instructions that, when executed by the one or more processing units, cause the content server to perform operations that include receiving, as an intermediary, a request from the computing device for information content from a specific publisher of the one or more publishers; requesting the information content from the specific publisher, wherein the information content includes advertising-related content and/or non-advertising-related content; receiving, from the specific publisher, the information content within a first media data; detecting the advertising-related content and/or non-advertising-related content within the information content; modifying the advertising-related content and/or non-advertising-related content to produce a modified information content; producing and inserting an execution code into the modified information content to produce a second media data; serving the second media data to the computing device; receiving from the computing device a request for the advertising-related content; requesting the advertising-related content and/or non-advertising-related content from the third-party networks; receiving the advertising-related content and/or non-advertising-related content from the third-party network; modifying the advertising-related content and/or non-advertising-related content to produce a modified advertising-related content and/or non-advertising-related content; inserting the modified advertising-related content and/or non-advertising-related content into second media data to produce an updated second media data; and serving the updated second media data to the computing device in a manner where it may be accessed by the computing device when the execution code is invoked by an end user of the computing device.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system diagram of an example of an implementation of a content server within a system environment, where the content server manages media data that is produced by one of more publishers and an advertising network and delivered to a computing device in accordance with the present disclosure.

FIG. 2 is a system diagram of an example of an implementation of a display of the computing device shown in FIG. 1 in accordance with the present disclosure.

FIG. 3 is a system diagram of an example of an implementation a device of the one or more devices, shown in FIG. 1, configured to receive requests from the computing device, send requests for media data from the one or more publishers and advertising network, receiving second media data, third media data from the one or more publishers and advertising network, and sending the first media data to the computing device, respectively, in accordance with the present disclosure.

FIG. 4 is a flowchart of an example of an implementation of a method for initially setting up the content server with the computing device and specific producer, shown in FIG. 1, in accordance with present disclosure.

FIG. 5 is a flowchart of an example of an implementation of another method for the interaction of the content server with advertising networks shown in FIG. 1 in accordance with present disclosure.

FIG. 6 is a flowchart of an example of an implementation of another method for the interaction of the content server with third-party networks shown in FIG. 1 in accordance with present disclosure.

FIG. 7 is a command flow diagram showing an example of an implementation of the operation of the content server for the advertising network shown in FIG. 1 in accordance with the present disclosure.

FIG. 8 is a command flow diagram showing an example of an implementation of the operation of the content server for the information network shown in FIG. 1 in accordance with the present disclosure.

FIG. 9 is a system block diagram of an example of another implementation of a content server in accordance with the present disclosure.

### DETAILED DESCRIPTION

A content server for managing media data between one or more publishers, third-party networks, and a computing device is disclosed. The content server includes one or more processing units and a computer-readable media. The computer-readable media stores instructions that, when executed by the one or more processing units, cause the content server to perform operations that include receiving, as an intermediary, a request from the computing device for information content from a specific publisher of the one or more publishers; requesting the information content from the specific publisher, wherein the information content includes advertising-related content and/or non-advertising-related content; receiving, from the specific publisher, the information content within a first media data; detecting the advertising-related content and/or non-advertising-related content within the information content; modifying the advertising-related content and/or non-advertising-related content to produce a modified information content; producing and inserting an execution code into the modified information content to produce a second media data; serving the second media data to the computing device; receiving from the computing device a request for the advertising-related content; requesting the advertising-related content and/or non-advertising-related content from the third-party networks; receiving the advertising-related content and/or non-advertising-related content from the third-party network; modifying the advertising-related content and/or non-advertising-related content to produce a modified advertising-related content and/or non-advertising-related content; inserting the modified advertising-related content and/or non-advertising-related content into second media data to produce an updated second media data; and serving the updated second media data to the computing device in a manner where it may be accessed by the computing device when the execution code is invoked by an end user of the computing device.

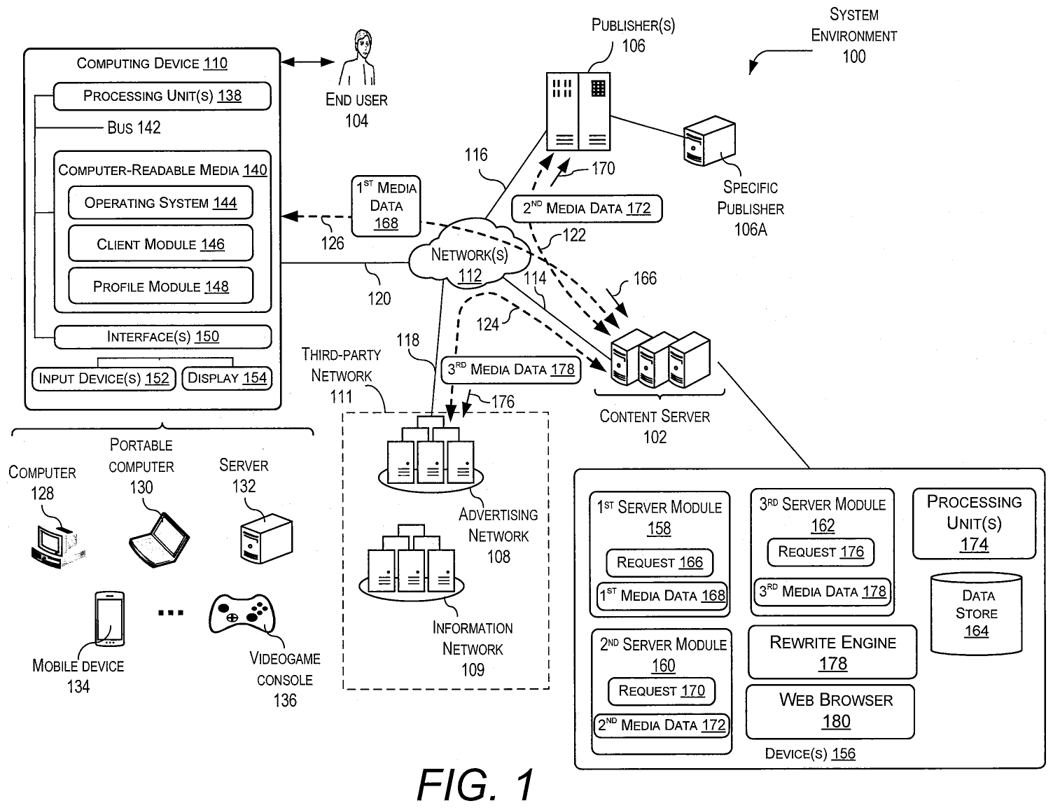

Various examples, scenarios, and aspects are described below with reference to FIGS. 1-7.

In FIG. 1, a system diagram is shown illustrating an example of an implementation of a system environment 100 in where a content server 102 manages media data (such as advertising content) according to the present disclosure. The system environment 100 includes the content server 102 (which may be a proxy server) having one or more servers that acts as an intermediary between an end user 104, one or more publishers 106 of internet content, and an advertising network 108 intent on delivering advertisements to the end user 104. In this example, the content server 102, one or more publishers 106, advertising network 108, and a computing device 110 are in signal communication with one or more telecommunication networks 112 via signal paths 114, 116, 118, and 120, respectively. In this example, the one or more telecommunication networks 112 may include, for example, public networks such as the Internet, private networks such as an institutional and/or personal intranet, or some combination of private and public networks. In this example, the advertising network 108 is part of a third-party network 111.

As another example, the system environment 100 may also include an information network 109 either instead of, or in addition to, the advertising network 108 as part of the third-party network 111. In this example, the information network 109 is intent on delivering non-advertisement information to the end user 104. This non-advertisement information may include for example, financial information (such as, for example, stock prices, equity fund information, pension fund information, banking information, etc.), mapping information and applications, business information analytics, etc.

The one or more telecommunication networks 112 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. The one or more telecommunication networks 112 may utilize communications protocols, including packet-based and/or datagram-based protocols such as Internet protocol (“IP”), transmission control protocol (“TCP”), user datagram protocol (“UDP”), or other types of protocols. Moreover, the one or more telecommunication networks 112 may also include a number of devices that facilitate network communications and/or form a hardware basis for the networks, such as switches, routers, gateways, access points, firewalls, base stations, repeaters, backbone devices, and the like.

In some examples, the one or more telecommunication networks 112 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In this example, the content server 102 is shown in signal communication with both the one or more publishers 106 and advertising network 108 via signal paths 122 and 124, respectively. In this example, the signal path 122 includes the signal paths 114, 116, and one or more telecommunication networks 112 and the signal path 124 includes the signal paths 114, 118, and one or more telecommunication networks 112. Moreover, the content server 102 is also in signal communication with a computing device 110 (which is operated by the end user 104) via a signal path 126 that includes signal paths 114, 120 and the one or more telecommunication networks 112.

The one or more publishers 106 may be any producer of internet content, such as a web page that is to be displayed to the end user 104 on the computing device 110. The one or more publishers 106 may also reside on one or more servers that are remote from the client server 102. The advertising network 108 also may be a set of one or more servers that are collectively utilized to select advertisements and produce an advertising resource, such as an image or an interactive block or script, for presentation to the end user 104 on the computing device 110.

In this example, the computing device 110 may be a computer 128, portable computer 130, server 132, mobile device 134 (such as a smart telephone, tablet, etc.), videogame console 136, etc. In general, the computing device 110 may include one or more computing devices that operate in a cluster or other grouped configuration to share resources, balance load, increase performance, provide fail-over support or redundancy, or for other purposes. For instance, the computing device 110 may belong to a variety of classes of devices such as traditional server-type devices, desktop computer-type devices, and/or mobile-type devices. Thus, although illustrated as a single type of device, a server-type device, the computing device 110 may include a diverse variety of device types and are not limited to a particular type of device. The computing device 110 may represent, but are not limited to, server computers, desktop computers, web-server computers, personal computers, mobile computers, laptop computers, tablet computers, videogame consoles, mobile-type devices, special purpose-type devices, embedded-type devices, wearable-type devices, or any other sort of computing device. As such, the computing device 110 may be expanded to a device that includes, but is not limited to, a desktop computer (such as computer 128), a game console and/or a gaming device (such as videogame console 134), a tablet computer, a personal data assistant (“PDA”), a mobile phone/tablet hybrid (such as mobile device 134), a laptop computer (such as portable computer 130), a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device.

In some implementations, the computing device 110 includes one or more input/output (“I/O”) interfaces 150 that enable communications with input/output devices such as user input devices 152 including peripheral input devices (e.g., a game controller, a keyboard, a mouse, a pen, a voice input device, a touch input device, a gestural input device, and the like) and/or output devices including peripheral output devices (e.g., a display 154, a printer, audio speakers, a haptic output device, and the like). The computing device 110 may also include a combination of two or more devices, such as a mobile phone in combination with a wearable device.

The computing device 110 may represent any type of computing device having one or more processing units 138 in signal communication to a computer-readable media 140 via a bus 142, which in some instances may include one or more of a system bus, a data bus, an address bus, a PCI bus, a Mini-PCI bus, and any variety of local, peripheral, and/or independent buses. Executable instructions stored on the computer-readable media 140 can include, for example, an operating system 144, a client communication module 146, a profile module 148, and other modules, programs, or applications that are loadable and executable by the one or more processing units 138.

The computing device 110 can also include the one or more interface(s) 150 to enable communications between the computing device 110 and other networked devices, such as the content server 102. The network interface(s) 124 can include one or more network interface controllers (“NICs”) or other types of transceiver devices to send and receive communications and/or data over the one or more networks 112.

In this example of the system environment 100, the computing device 110 utilizes its client communication module 146 to connect with the client server 102 and/or other external device(s) through the one or more telecommunication networks 112. In various examples, the computing device 110 utilizes its profile module 148 to generate user profiles for communicating with other devices (such as content server 102) over the one or more telecommunication networks 112. In general, a user profile may include one or more of an identity of a user (e.g., a name, a unique identifier (“ID”), etc.), a user avatar, personal data (e.g., age, title, position, etc.), location data, status data (e.g., online, offline, available, busy, etc.) and so forth.

The content server 102 may be any device, network, or system that can communicate with and act as an intermediary between the end user 104, the one or more publishers 106, and/or the advertising network 108 in accordance with one or more features of the present disclosure. For example, the content server 102 may be in the form of a cloud proxy or cloud network made up of one or more servers.

It is appreciated by those skilled in the art that the circuits, components, modules, and/or devices of, or associated with, the content server 102 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

In this example, the end user 104 is an individual but may be an automated device of software component of module capable of interfacing with the computing device 110 to search the one of more telecommunication networks 112 such as, for example, the Internet. As an example, the computing device 110 may also include a software application (i.e., program) for browsing (i.e., searching and viewing information) the Internet, where the software application is stored on a memory unit within the computing device 110. This software application may be a web-browser (commonly referred to as a browser) for accessing information on the World Wide Web that is part of the Internet. At present, examples of known browsers include, for example, Google Chrome® produced by Google LLC. of Mountain View, Calif., Mozilla Firefox® produced by Mozilla Foundation of Mountain View, Calif., Safari® produced by Apple, Inc. of Cupertino, Calif., and Internet Explorer® and Edge® produced by Microsoft Corporation of Redmond, Wash. The executable instructions of the browser are loaded in the computer-readable media 140 for execution by the one or more processors 138 of the computing device 110. In general, the computer-readable media 140 is a computer or machine-readable medium that is a medium capable of storing data in a format readable by a computer and/or mechanical device rather than human readable.

The browser may display information to the end user 104 on the display 154 of the computing device 110, which may be, for example, a screen on a computer, television, or hand-held device. The displayed information on the display 154 may contain one or more blocks of content, which may include a publisher block that visually displays Internet content created by the one or more publishers 106 and one or more advertising blocks that display advertising-related content, such as an advertisement, created by or delivered by the advertising network 108.

Alternatively or additionally, the display 154 and other output devices of the computing device 110 may communicate with the end user 104 through an audio and/or tactile means, and the blocks of content may include audio and/or tactile data or the like.

In this disclosure, the content server 102 provides a manner and method for improving and/or optimizing delivery of advertising-related content. The delivery mechanism utilized by the content server 102 ensures that only the information that is explicitly allowed by the one or more publishers 106 and/or the end user 104 is shared with the advertising network 108 and any advertising entities associated with the advertising network 108.

The content server 102 acts as an intermediary between the end user 104 and the advertising network 108 and applies multiple network and content optimization techniques to achieve reduced latency and improved efficiency while controlling any delivered and shared information with the end user 104. In particular, the privacy of the end user 104 privacy is protected in a manner governed by the one or more publishers 106 and/or the preferences of the end user 104. The content server 100 provides flexible opt-in and opt-out options for protecting the privacy of the end user 104 in a consistent manner and the operation of content server 100 may be enforceable by the end user 104 and/or the one or more publishers 106 who have the ownership of the content that the end user 104 is desirous of consuming.

The content server 102 also ensures that only pre-approved advertisements can be displayed on the display 154 of the computing device 110 and that no third-party code (such as code from an advertiser of the advertising network 108) can be injected into the Internet content served to the end user 104 without the consent of the one or more publishers 106 and in accordance with the end user 104 declared preferences. Moreover, no security vulnerabilities may be incurred in the process of serving and displaying the advertisements from the one or more publishers 106 to the end user 104.

In this disclosure, the content server 102 operates differently than convention internet interactions to help improve the end user 104 experience. Specifically, in a conventional system, the one or more publishers 106 would communicate directly with the computing device 110. The computing device 110 would resolve the domain name of a given publisher of the one or more publishers 106 and connect directly to a web server of the given publisher. The given publisher would prepare the Internet content and directly push that content to the computing device 110 where the Internet content is rendered for delivery to the end user 104, via a browser window of the browser or the like, to be displayed in a publisher block on the display 154 either within the browser window or separate window displayed on the display 154.

In the convention system, the rendered content also contains Internet hyperlink references to at least one advertiser of the advertising network 108 that allows the at least one advertiser, as a third-party, to directly deliver scripts, documents, or advertisements to the computing device 110, where these scripts, documents, or advertisements are executed along with the Internet content provided by the one or more publishers 106.

In contrast, the content server 102 does not allow the one or more publishers 106 or the advertising network 108 to communicate directly with the computing device 110. Instead, the one or more publishers 106 and the advertising network 108 communicate indirectly with the computing device 110 through the content server 102 that acts as an intermediary between the one or more publishers 106 and the advertising network 108 and the computing device 110. By the content server 110 acting as an intermediary, the content server 110 of the present disclosure offers many advantages over the earlier described conventional system, particularly to the end user 104 experience. In this disclosure, the content server 102 establishes a direct connection with the computing device 110, via signal path 126, and has an established direct connection with the one or more publishers 106, via signal path 122, and an established direct connection with the advertising network 108 via signal path 124.

The content server 102 includes one or more devices 156. The one or more devices 156 and/or components of the content server 102 can include distributed computing resources that communicate with one another and/or with the computing device 110, the one or more publishers 106, and the advertising network 108 via the one or more telecommunication networks 112.

In various examples, the one or more devices 156 may operate in a cluster or other grouped configuration to share resources, balance load, increase performance, provide fail-over support or redundancy, or for other purposes. As an example, the one or more devices 156 of the content server 102 includes a first server module 158, second server module 160, third server module 162, and a data storage 164.

As an example, the first server module 158 is configured to receive, from the end user 104 utilizing the computer device 110, a domain name resolution request 166 for a specific publisher 106A of the one or more publishers 106. Typically, the end user 104 will use a search engine link or type in a domain name with the input device 152 for the specific publisher 106A of the one or more publishers 106 rather than using an Internet protocol (“IP”) address. The domain name is converted to the IP address via a procedure called domain name service (“DNS”) resolution or DNS lookup in conventional fashion.

In this example, the specific publisher 106A will have its IP address associated with the content server 102 such that when the computing device 110 attempts to contact the specific publisher 106A, the computing device 110 will be receive the IP address for the contact server 102 instead of an IP address for the specific publisher 106A of the one or more publishers 106. The computing device 110 thus connects to the content server 102 and requests 166 Internet first media data 168 from the specific publisher 106A. In this example, the first media data 168 may be, for example, a web-page. The first server module 158 receives the request 166 for the first media data 168 and, in response, the content server 102 makes a request 170 for second media data 172 from the specific publisher 106A of the one or more publishers 106. The specific publisher 106A of the one or more publishers 106 receives the request 170 of the second media data 172 and, in response, creates and sends the second media data 172 to the second server module 160. The content server 102 then detects any advertising-related content (such as, for example, one or more advertisement blocks or scripts) in the second media data 172 from the specific publisher 106A. If there is any advertising-related content in the second media data 172, the content server 102 modifies the advertising-related content in the second media data 172 to produce the first media data 168 by, for example, rewriting the second media data 172 and the associated advertising-related content with one or more processing units 174 within the content server 102. The content server 102 then transmits the first media data 168 to the computing device 110.

As an example, the content server 102 may modify the advertising-related content by scrambling it to produce the first media data 168 that is transmitted to the computing device 110. The content server 102 may also remove any explicit references to advertising-related content and/or links that might be intercepted by an ad-blocking program running on the computing device 110. Moreover, the content server 102 may also construct within the first media data 168 an execution code that is executable by the one or more processing units 138 on the computing device 110. In this example, when the execution code within the first media data 168 is executed by the one or more processing units 138 within the computing device 110, the execution code restores the original references to the advertising-related content within the first media data 168. As a further example, the advertising-related content within the first media data 168 may be scrambled or obfuscated and the execution code descrambles of un-obfuscates the advertising-related content when the execution code is executed or invoked by the one or more processing units 138 of the computing device 110. The modified advertising-related content within the first media data 168 is thus able to be delivered to the end user 104 utilizing the computing device 110 in a manner where it is more efficiently and speedily delivered and/or in a manner where is can go undetected by ad blocking programs running on the computing device 110.

When the execution code within the first media data 168 is executed by the computing device 110, the computing device 110 and the content server 102 utilize an already existing connection or create a connection, such as a persistent connection via signal path 126. As an example, an additional persistent connection via signal path 126 may be accomplished by using a websocket, where a websocket is a computer communications protocol providing multiple communication channels over a single transmission control protocol. In this example, the websocket protocol is RFC 6455. The execution code running within the computing device 110 also continuously pushes information to the content server 102 about the browser information displaying on the display 154 of the computing device 110, such as window dimensions, position of the scroll bar, cursor, and other run time details in addition to updates on the individual behavior of the end user 104 while utilizing the computing device 110.

Once the connection is established between the computing device and the content server 102, the content server 102 interacts with the advertising network 108 via signal path 124. A connection between the content server 102 and the advertising network 108 is established along the signal path 124. For each advertising-related content (such as one or more advertising blocks or scripts that are to be displayed on the display 154 of the computing device 110) that was modified by the content server 102 and transmitted to the computing device 110, the content server 102 requests 176 a third media data 178, with the third server module 162, having advertising-related content, such as an advertisement that is to be transmitted to the computing device 110 according to an existing programmatic advertisement generation and fulfilment procedures. This process results in no changes to standard protocols and algorithms on the advertising platforms side of the advertising network 108.

The advertising network 108 then transmits the advertisement (within the third media data 178) to the third server module 162 that is to be displayed on the display 154 of the computing device 110 to the end user 104. The content server 102 then translates the advertisement within the third media data 178 by modifying it, such as by rewriting and/or scrambling it with the one or more processing units 174. The computer device 110 then receives the advertising-related content, within the first media data 168, and invokes or executes the execution code with the one or more processing units 138 of the computing device 110 to access the advertising-related content, such as, for example, by descrambling the advertising-related content. The advertising-related content, such as an advertisement, can then be displayed on display 154 of the computing device 110 to be viewed by the end user 104. Additionally or alternatively, the content server 115 may perform other functions, such as performing fraud checks on the advertising-related content, before delivering the advertisement to the computing device 110.

The content server 102 utilizes the flow of information to create a server-side browser-like environment. The browser-like environment is used to execute the modified Internet content including excised and/or rewritten advertising blocks or scripts. The blocks or scripts of the advertising network 108 are thus getting executed as if they were on the computing device 110, while in a simulated browser-like environment that mimics the browser of the computing device 110 with improved fidelity.

As an example, the communication with the advertising network 108 and the rewriting of the advertising content is achieved by a server-side browser (i.e., at the content server 102) shadowing environment and/or end user-side (i.e., at the computing device 110) instrumentation. This approach may utilize Javascript and rewriting uniform resource locators (“URLs”) in Javascript in a corporate environment, where these functions may be implemented within a clientless or browser-based secure sockets layer (“SSL”) virtual private network (“VPN”) gateways providing secure remote access to internal resources. In general, URL rewriting allows a URL to be separated from a resource such that the URL and the resource that it leads to can be independent of each other. In this disclosure, URL rewriting (also known as URL manipulation) allows the end user 104 utilizing the computing device 110 to link to a URL of a specific publisher 106A of the one or more publishers that has been rewritten to direct the link to the original URL to a new URL at the content server 102 in a way that is transparent to the computing device 110 and end user 104. In general, URL rewriting is a process of altering (often automatically by means of a software program) the parameters in a URL. It is a way of implementing URL mapping or routing within a web application. The web application (also known as a web app) is a client-server computer program that the client (i.e., the computing device 110) runs in a web browser. In this example, a software program that automatically performs URL rewriting is generally known as rewrite engine. In this example, the one or more devices 156 of the content server 102 is shown also including a rewrite engine 178 module that is associated with a web browser application 180 on the content server 102, where the rewrite engine 178 may be a component of the web browser application 180 or a web application framework (also known as a web framework). The web framework is a software framework that is designed to support the development of web applications that include, for example, web services, web resources (i.e., a resource located on the one or more telecommunication networks 112), and web application programming interfaces (“APIs”).

In all of these examples, the one or more devices 156 of the content server 102 may also include the data storage 164 such as, for example, a memory unit to store any needed information related the first media data 168, second media data 172, or third media data 178.

In this disclosure, the content server 102 is configured to improve and optimizing delivery of advertising-related content to the end user 104 of the computing device 110. The content server 102 acts as an intermediary between the end user 104 and advertisers and applies multiple network and content optimization techniques to achieve reduced latency and improved efficiency while controlling delivered and shared information. The delivery mechanism described ensures that only the information that is explicitly allowed by the specific publisher 106A of the one or more publishers 106 and/or the computing device 110 is shared with the advertising network 108.

In particular, the content server 102 protects the privacy of the end user 104 in a manner governed by the specific publisher 106A and/or preferences of the end user 104 utilizing the computing device 110. Moreover, the adverse effect of ad blockers on the specific publisher 106A and advertising network 108 is eliminated by delivering all advertisements through the content server 102 as the first media data 168 that includes the modified data from both the second media data 172 and third media data 178. As such, ad fraud is detected and curtailed by reducing the ability of malicious browser plug-ins and network bots to impersonate legitimate users or entities.

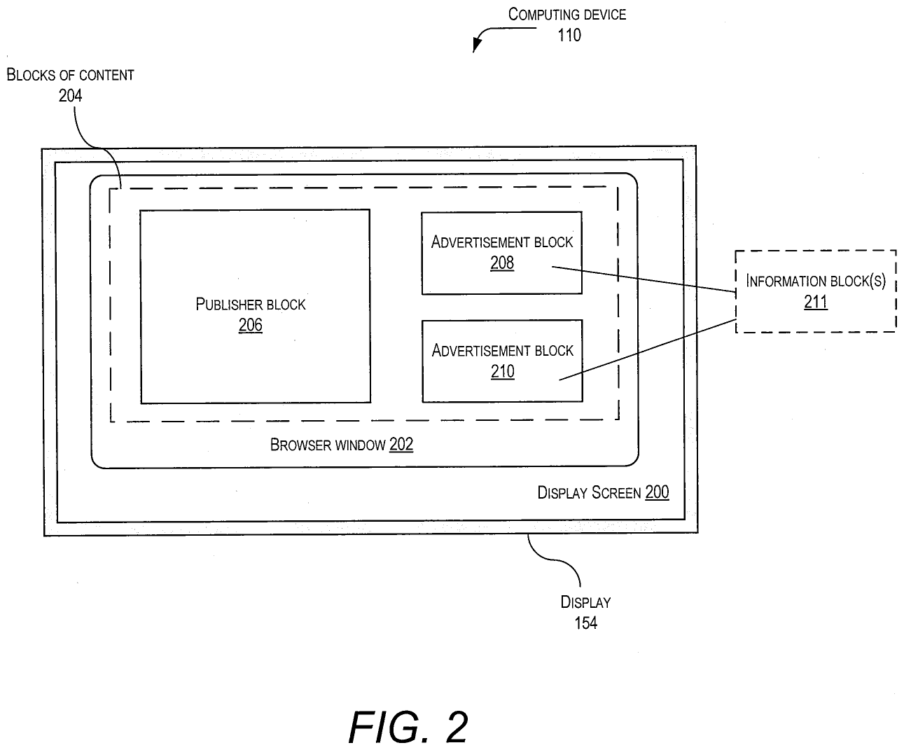

Turning to FIG. 2, a system diagram of an example of an implementation of the display 154 of the computing device 110 in accordance with the present disclosure. In this example, the display 154 includes a display screen 200. As described earlier, the computing device 110 may run a web browser that displays a browser window 202 on the display screen 200. As described earlier, the browser window 202 may display information to the end user 104 on the display screen 200, which may be information that includes one or more blocks of content 204, which may include a publisher block 206 that visually displays Internet content created by the specific publisher 106A and one or more advertising blocks 208 and 210 that display advertising-related content, such as an advertisement, created by or delivered by the advertising network 108.

As discussed earlier, the system environment 100 may also include the information network 109 either instead of or in addition to the advertising network 108. In this example, the information network 109 is intent on delivering non-advertisement information to the end user 104. This non-advertisement information may include for example, financial information (such as, for example, stock prices, equity fund information, pension fund information, banking information, etc.), mapping information and applications, business information analytics, etc. In this example, the blocks of content 204 may include one or more information blocks 211 either instead of or in addition to the one or more advertising blocks 208 and 210. Again, these one or more information blocks 211 may include non-advertisement information that may be, for example, financial information, mapping information and applications (such as, for example, geographic information systems (“GIS”) such as Mapquest, Google maps, Apple Maps, etc.), business information analytics, etc.

Moreover, as also discussed earlier, alternatively or additionally, the display screen 200 may communicate to the end user 104 through an audio and/or tactile means, and the blocks of content 204 may include audio and/or tactile data or the like.

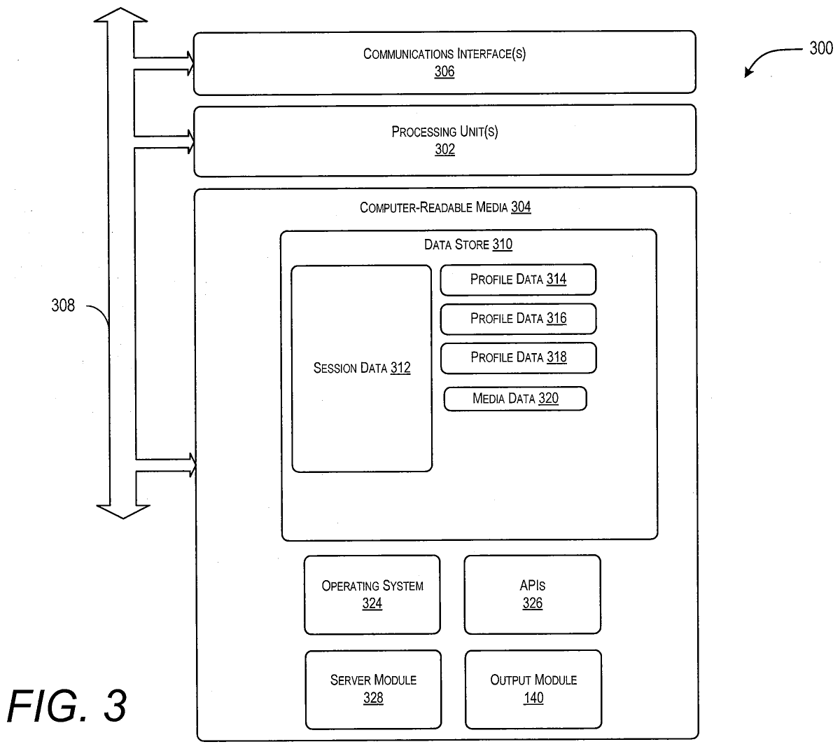

In FIG. 3, a system diagram of an example of an implementation of components of a device 300, such as a device of the one or more devices 156, is shown configured to receive requests 166 from the computing device 110, send requests 170 and 176 for media data from the one or more publishers 106 and advertising network 108, receiving second media data 172, third media data 178 from the one or more publishers 106 and advertising network 108, and sending the first media data 168 to the computing device 110, respectively. In this example, the device 300 includes one or more processing unit(s) 302, computer-readable media 304, and/or communication interface(s) 306. The components of the device 300 are in signal communication and operatively connected, for example, via a bus 308, which can include one or more of a system bus, a data bus, an address bus, a PCI bus, a Mini-PCI bus, and any variety of local, peripheral, and/or independent buses.

As utilized herein, the processing unit(s) may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized in this disclosure, a computer-readable media, such as computer-readable media 304 and/or computer-readable media 140, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 306 may represent, for example, network interface controllers (“NICs”) or other types of transceiver devices to send and receive communications over a network.

The computer-readable media 304 can include the data store 310. In some examples, the data store 310 includes data storage such as a database, data warehouse, or other type of structured or unstructured data storage. In some examples, the data store 310 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 310 can store data for the operations of processes, applications, components, and/or modules stored in computer-readable media 304 and/or executed by processing unit(s) 302 and/or accelerator(s). For instance, in some examples, the data store 310 can store session data 312 (between the computing device 110 and specific publisher 106A), profile data 314 for the computing device 110, profile data 316 for the specific publisher 106A, profile data 318 for the advertising network, requests 320 (such as, for example, requests 166, 170, and 176), media data 322 (such as, for example, first media data 168, second media data 172, and third media data 178), and/or other data. The computer-readable media 304 can also include operating system 324 and APIs 326 configured to expose the functionality and the data of the device 300 to external devices associated with content server 102. Additionally, the computer-readable media 304 includes one or more modules 328 and one or more output modules 330. In this example, the data store 304 may be part of the data store 164 shown in FIG. 1.

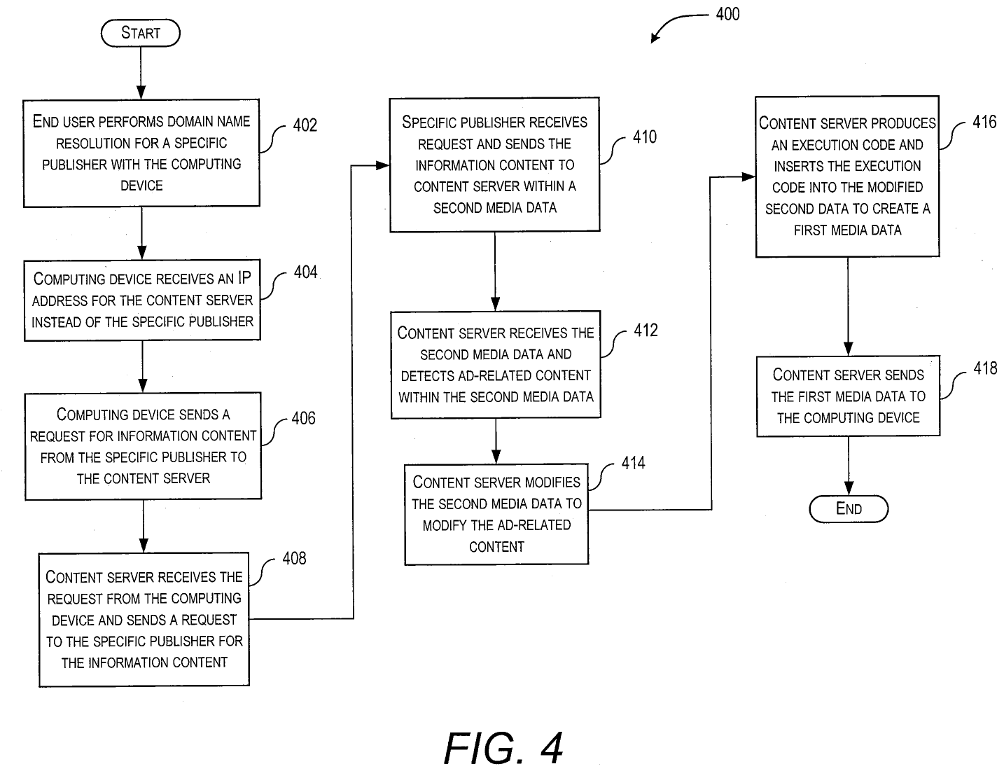

FIG. 4 is a flowchart illustrating an example of an implementation of a first method 400 of operation in initially setting up the content server 102 with the computing device 110 and specific producer 106A in accordance with present disclosure. The method 400 starts when the end user 104 utilizes the computing device 110 to perform 402 a domain name resolution for the specific publisher 106A, of the one or more publishers 106. As discussed previously, the end user 104 will typical utilize a search engine link or input the domain name for the specific publisher 106A rather than use an IP address for the specific publisher 106A. When the end user 104 inputs the domain name into an Internet browser running on the computing device 110, the domain name is converted into an IP address via DNS resolution.

In this example, the specific publisher 106A is registered with a service entity that controls and operates the content server 102 such that the process of DNS resolution produces an IP address for the content server 102 instead of the actual IP address for the specific publisher 106A. The computing device 110 thus receives 404 the IP address for the content server 102 instead of the IP address for the specific publisher 106A. Once the computing device 110 receives the IP address for the content server 102, the end user 104 then utilizes the computing device 110 to send 406 request 166 (shown in FIG. 1) for information content from the specific publisher 106A. Since the computing device 110 is in signal communication with the content server 102 and not the specific publisher 106A, the request 166 for information content is sent to the content server 102 instead of the specific publisher 106A. As an example, the requested information content may be a webpage or other media data from the specific publisher 106A.

Since the content server 102 does not generally have the requested information content from the specific publisher 106A, once the content server 102 receives the request 166 from the computing device 110, the content server 102 sends 408 a request 170 to the specific publisher 106A for the requested information content requested by the end user 104 utilizing the computing device 110. The specific publisher 106A receives the request 170 from the content server 102 and sends 410 the requested information content to the content server 102 as the second media data 172 (shown in FIG. 1). The content server 102 receives the second media data 172 and detects 412 any advertising-related (i.e., ad-related) content within the second media data 172 such as, for example, one or more advertisement blocks or scripts. The content server 102 then modifies 414 the second media data 172 by, for example, rewriting the second media data 172. In this step, the requested information content and/or ad-related content, within second media data 172, may be modified by the content server 102. As an example, the content server 102 may modify the second media data 172 by scrambling the ad-related content within the second media data 172. In this example, the modified second media data 172 that includes the modified ad-related content is configured to be sent to the computing device 110 as the first media data 168. As part of the modification process performed by the content server 102, the content server 102, for example, utilizes the rewrite engine 178 to rewrite the second media data 172 to remove any explicit references to ad-related content and links. Moreover, the content server 102 produces 416 an execution code that is executable by the computing device 110 and includes the execution code within the first media data 168 prior to sending the first media data 168 to the computing device 110. The content server 102 then sends 418 the first media data 168 to the computing device 110 and the process ends.

In this example, once the computing device 110 receives the first media data 168 and executes the execution code, the execution code restores the original references to the ad-related content from the specific publisher 106A. As an example, the ad-related content within the first media data 168 may be scrambled or obfuscated, and the execution code descrambles or un-obfuscates the ad-related content when the execution code is executed or invoked by the end user 104 utilizing the computing device 110. The modified ad-related content is thus able to be delivered to the computing device 110 in a manner where it is more efficiently and speedily delivered and/or in a manner where the ad-related content can go undetected by ad blockers running on the computing device 110.

As discussed earlier, when the execution code is executed by the computing device 110, the computing device 110 and the content server 102 utilize an already existing connection or create a connection, such as a persistent connection. As also discussed earlier, an additional persistent connection is accomplished by utilizing a websocket that may be, for example, the websocket protocol is RFC 6455. In this example, the execution code running within the computing device 110 also continuously pushes information to the content server 102 about the browser information of the computing device 110, such as browser window 202 dimensions, position of the scroll bar, cursor, and other run time details in addition to updates on the behavior of the end user 104.

In another example, as discussed earlier, the system environment 100 may also include the information network 109 either instead of or in addition to the advertising network 108. In this example, the information network 109 is intent on delivering non-advertisement information to the end user 104. This non-advertisement information may include for example, financial information, mapping information and applications, business information analytics, etc. In this example, the blocks of content 204 may include one or more information blocks 211 either instead of or in addition to the one or more advertising blocks 208 and 210. Again, these one or more information blocks 211 may include non-advertisement information that may be, for example, financial information, mapping information and applications, business information analytics, etc. As such, in this example, content server 102 receives the second media data 172 and detects 412 any advertising-related or non-advertising content within the second media data 172 such as, for example, one or more advertisement or information data blocks or scripts. The content server 102 then modifies 414 the second media data 172 by, for example, rewriting the second media data 172.

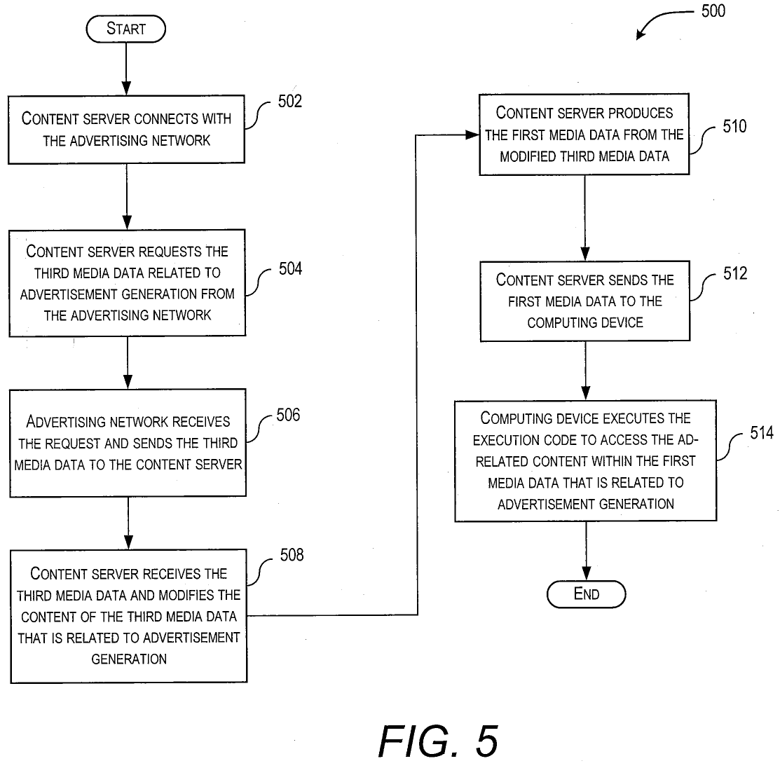

Turning to FIG. 5, a flowchart illustrating an example of an implementation of another method 500 of the interaction of the content server 102 with advertising networks 108 is shown in accordance with present disclosure. In this example, once the signal communication is established between the computing device 110 and the content server 102, the content server 102 interacts with the advertising network 108 as shown in FIG. 1. For each advertising-related content, such as one or more advertising blocks or scripts, that was modified and served to the computing device 110, the content server 102 requests advertising-related content, such as an advertisement, to be delivered or served to the computing device 110 according to existing programmatic advertisement generation and fulfilment procedures, thus resulting in no changes to standard protocols and algorithms on the advertising platforms side.

In this example, the method 500 starts by the content server 102 connecting 502 with the advertising network 108 via signal path 124. The content server 102 then sends 504 a request 176 for the third media data 178 from the advertisement network 108. The third media data 178 is information data/content that is related to the advertisement generation from the advertising network 108. As an example, this information data/content may be the ad-related data, content, and/or information that would have been hyperlinked directly from an ad-related block listed on a webpage of the specific publisher 106A but is now provided by the content server 102 by combining the information from specific publisher 106A with the second media data 172 and the ad-related information from the advertising network 108 with the third media data 178.

The advertising network 108 receives the request 176 from the content server 102 and, in response, sends 506 the third media data 178 to the content server 102. The content server 102 receives the third media data 178 and modifies 508 the ad-related content of the third media data 178 that is related to advertisement generation. The content server 102 modifies the third media data 178 by, for example, rewriting and/or scrambling the ad-related content. The content server 102 then produces 510 the first media data 168 from the modified third media data 178. As discussed earlier, the content server 102 may produce the first media data 168 from both the second media data 172 and the third media data 178. The content server 102 then sends 512 the first media data 168 to the computing device 110. As described earlier, the first media data 168 includes execution code(s) and the computing device 110 executes 514 the execution code(s) to access the ad-related information, data, and/or content within the first media data 168 that is related to advertisement generation. The method 500 then ends.

In this example, the computing device 110 access the ad-related information, data, and/or content within the first media data 168 by, for example, descrambling that ad-related information, data, and/or content from the first media data 168 by executing the execution code within the first media data 168. As a result, the ad-related information, data, and/or content may be viewed on the display 154 of the computing device 110.

Additionally or alternatively, the content server 102 may perform other functions, such as, for example, performing fraud checks on the advertising-related content, before delivering 512 the advertisement to the computing device 110 within the first media data 168. As a result, the content server 102 utilizes the flow of information to create a server-side browser-like environment. The browser-like environment is used to execute the modified Internet content including excised and/or rewritten advertising blocks or scripts. The blocks or scripts of advertising network 108 are being executed as if they were being executed on the computing device 110, while in a simulated browser-like environment which mimics the web browser of the computing device 110 with improved fidelity.

As an example, the communication with the advertising network 108 and the rewriting of the advertising content is achieved by a server-side browser shadowing environment on the content server 102 and/or computing device-side instrumentation on the computing device 110.

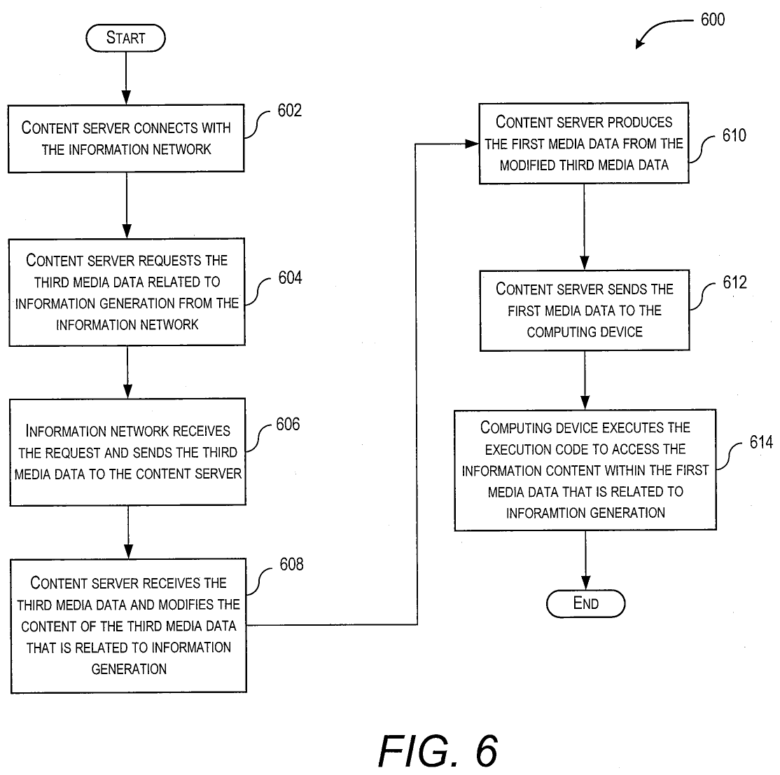

In FIG. 6, a flowchart illustrating an example of an implementation of another method 600 of the interaction of the content server 102 with information networks 109 is shown in accordance with present disclosure. Similar to the previous example, in this example, once the signal communication is established between the computing device 110 and the content server 102, the content server 102 interacts with the information network 109 as shown in FIG. 1. For each non-advertising-related information content, such as one or more information blocks or scripts, that was modified and served to the computing device 110, the content server 102 requests non-advertising-related information content, such as financial information, mapping information and applications, business information analytics, etc., to be delivered or served to the computing device 110 according to existing programmatic non-advertisement information generation and fulfilment procedures, thus resulting in no changes to standard protocols and algorithms on the information network 109 platforms side. In this example, this method 600 may be performed in combination with, or in instead of, the method 500 described in relation to FIG. 5.

In this example, the method 600 starts by the content server 102 connecting 602 with the information network 109 via signal path 124. The content server 102 then sends 604 a request 176 for the third media data 178 from the information network 109. The third media data 178 is information data/content that is related to the non-advertisement information generation from the information network 109. Again, as an example, this information data/content may be the financial information, mapping information and applications, business information analytics, etc., content, and/or information that would have been hyperlinked directly from an non-advertisement information block listed on a webpage of the specific publisher 106A but is now provided by the content server 102 by combining the information from specific publisher 106A with the second media data 172 and the non-advertisement information from the information network 109 with the third media data 178.

The information network 109 receives the request 176 from the content server 102 and, in response, sends 606 the third media data 178 to the content server 102. The content server 102 receives the third media data 178 and modifies 608 the non-advertisement information content of the third media data 178 that is related to advertisement generation. The content server 102 modifies the third media data 178 by, for example, rewriting and/or scrambling the non-advertisement information content. The content server 102 then produces 610 the first media data 168 from the modified third media data 178. As discussed earlier, the content server 102 may produce the first media data 168 from both the second media data 172 and the third media data 178. The content server 102 then sends 612 the first media data 168 to the computing device 110. As described earlier, the first media data 168 includes execution code(s) and the computing device 110 executes 614 the execution code(s) to access the non-advertisement information, data, and/or content within the first media data 168 that is related to non-advertisement information generation. The method 600 then ends.

In this example, the computing device 110 access the non-advertisement information, data, and/or content within the first media data 168 by, for example, descrambling that non-advertisement information, data, and/or content from the first media data 168 by executing the execution code within the first media data 168. As a result, the non-advertisement information, data, and/or content may be viewed on the display 154 of the computing device 110.

Additionally or alternatively, the content server 102 may perform other functions, such as, for example, performing fraud checks on the non-advertisement information content, before delivering 612 the advertisement to the computing device 110 within the first media data 168. As a result, the content server 102 utilizes the flow of information to create a server-side browser-like environment. The browser-like environment is used to execute the modified Internet content including excised and/or rewritten non-advertisement information blocks or scripts. The blocks or scripts of information network 109 are being executed as if they were being executed on the computing device 110, while in a simulated browser-like environment which mimics the web browser of the computing device 110 with improved fidelity.

As an example, the communication with the information network 109 and the rewriting of the non-advertisement information content is achieved by a server-side browser shadowing environment on the content server 102 and/or computing device-side instrumentation on the computing device 110.

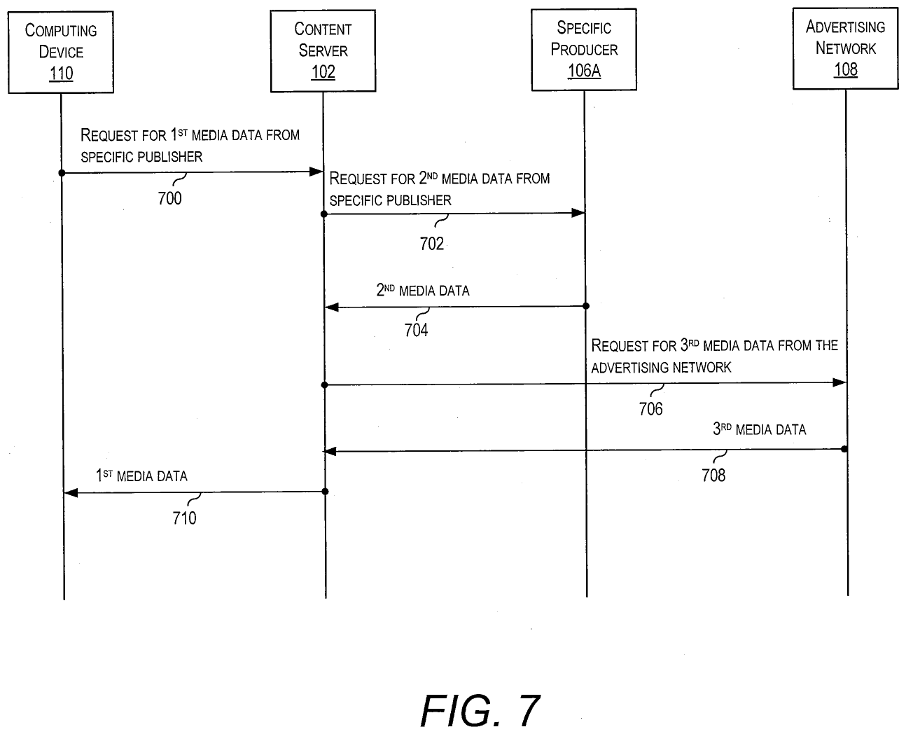

In FIG. 7, a command flow diagram showing an example of an implementation of the operation of the content server 102 in combination with the advertising network 108 in accordance with the present disclosure. In this example, the flow of the commands track the steps described in the methods described in relation to FIGS. 4 and 5. In this example, as described earlier, the end user 104 utilizes the computing device 110 to perform a domain name resolution for the specific publisher 106A, of the one or more publishers 106. Also as discussed previously, the computing device 110 receives the IP address for the content server 102 instead of the IP address for the specific publisher 106A. Once the computing device 110 receives the IP address for the content server 102, the end user 104 then utilizes the computing device 110 to send a request 166 for information content from the specific publisher 106A. Since the computing device 110 is in signal communication with the content server 102 and not the specific publisher 106A, the request 166 for information content is sent 700 to the content server 102 instead of the specific publisher 106A. Since the content server 102 does not generally have the requested information content from the specific publisher 106A, once the content server 102 receives the request 166 from the computing device 110, the content server 102 sends 702 a request 170 to the specific publisher 106A for the requested information content requested by the end user 104 utilizing the computing device 110. The specific publisher 106A receives the request 170 from the content server 102 and sends 704 the requested information content to the content server 102 as the second media data 172. The content server 102 receives the second media data 172 and detects any ad-related content within the second media data 172 such as, for example, one or more advertisement blocks or scripts. The content server 102 then modifies the second media data 172. In this step, the requested information content and/or ad-related content, within second media data 172 is modified by the content server 102. The modified second media data 172 that includes the modified ad-related content is configured to be sent to the computing device 110 as the first media data 168. In this example, as part of the modification process performed by the content server 102, the content server 102 utilizes the rewrite engine 178 to rewrite the second media data 172 to remove any explicit references to ad-related content and links and produce an execution code that is executable by the computing device 110. The execution code is included within the first media data 168 prior to sending the first media data 168 to the computing device 110. The content server 102 then connects with the advertising network 108 via signal path 124 and sends 706 a request 176 for the third media data 178 from the advertisement network 108. The advertising network 108 receives the request 176 from the content server 102 and, in response, sends 708 the third media data 178 to the content server 102. The content server 102 receives the third media data 178 and modifies 508 the ad-related content of the third media data 178 that is related to advertisement generation. The content server 102 then produces the first media data 168 from the modified second media data 172 and third media data 178. The content server 102 then sends 710 the first media data 168 to the computing device 110. As described earlier, the first media data 168 includes execution code(s) and the computing device 110 executes the execution code(s) to access the ad-related information, data, and/or content within the first media data 168 that is related to advertisement generation.

The content server 102 is constructed and configured in a way to improve and optimize the delivery of ad-related content to an computing device 110 and, as such, ultimately the end user 104. In general, the content server 102 acts as an intermediary between end users of computing devices and advertisers, and applies multiple network and content optimization techniques to achieve reduced latency and improved efficiency while controlling delivered and shared information. The delivery mechanism ensures that only the information that is explicitly allowed by the one or more publishers 106 and/or the end user 104 of the computing device 110 is shared with the advertising network 108. In particular, the privacy of the end user 104 can be protected in a manner governed by the preferences of the one or more publisher 106 and/or end user 104 of the computing device 110. In addition, the adverse effect of ad blockers on the computing device 110 is eliminated by delivering all advertisements through the content server 102 that is transparent to the ad blockers. By utilizing the content server 102, ad fraud is detected and curtailed by reducing the ability of malicious browser plug-ins and network bots to impersonate legitimate users or entities.

The content server 102 can reduce the lag time often associated with Internet advertisements when an advertising network 108 is allowed to display advertisements to an end user 104, of the computing device 110, as a third party. For example, while downloading a block or script of the advertising network 108, the browser of the computing device 110 might receive several redirects, JavaScript insertions and instructions to render more content from third and fourth party web servers that are part of the large advertising network 108. Once the final redirect or advertisement image insertion is performed, the final resource, such as an advertisement image, a flash block, or the like, is finally displayed in the appropriate position in browser widow 202 on the display 154 of the computing device 110 for presentation to the end user 104. These redirects can greatly slow the display process on the computing device 110.

As an example, the content server 102 intercepts and controls advertisements that result from a complex advertising network 108. In this example, the advertising network 108 may include one or more advertisers who interact with advertising creatives, market advertising servers, demand-side platforms (“DSP”), data management platforms (“DMP”), supply-side platforms (“SSP”), and advertising exchanges. The content server 102, of the present disclosure, servicing these exchanges on behalf of the end user preserves the current exchanges between the end users and advertising ecosystem with all of these interactions.

Thus, the content server 102 can act as a tunnel to the computing device 110 and ultimately the end user 104. The content server 102 can front-end all advertising network entities (advertisers, DSPs, DMPs, SSPs, publishers, etc.) to the computing device 110. The content server 102 can create a single, unique marker (cookie, supercookie, or the like) to track the computing device 110 while aliasing all third party trackers to this single marker. The content server 102 can keep a mapping of all third party trackers to this single marker and thereby transparently communicate on behalf of the end user 104 to these third-party systems.

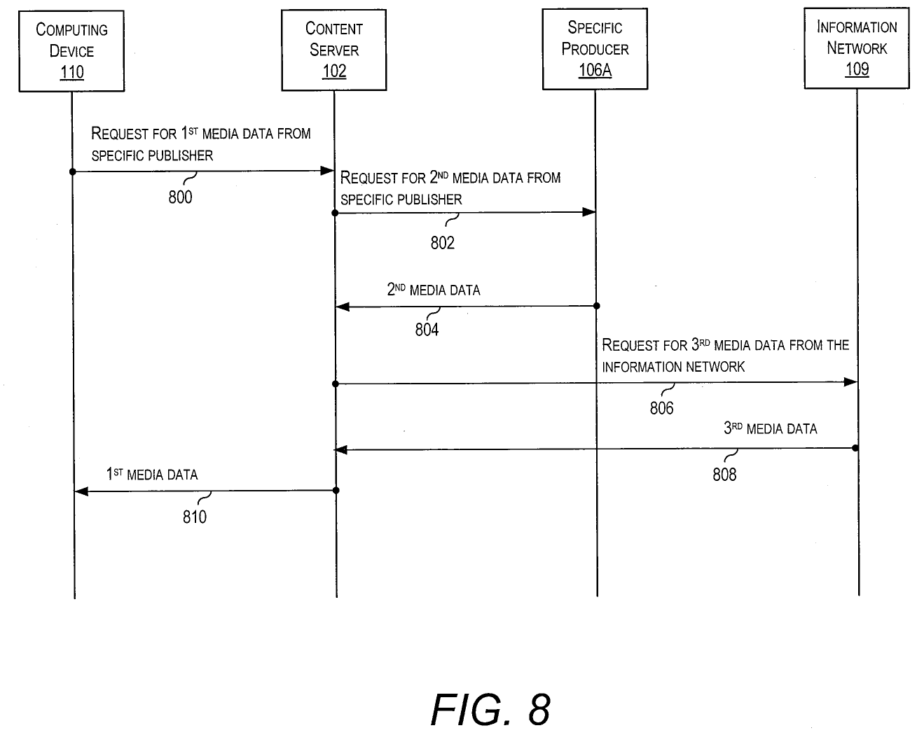

In FIG. 8, a command flow diagram showing an example of an implementation of the operation of the content server 102 in combination with the information network 109 in accordance with the present disclosure. In this example, the flow of the commands track the steps described in the methods described in relation to FIGS. 4 and 6. In this example, as described earlier, the end user 104 utilizes the computing device 110 to perform a domain name resolution for the specific publisher 106A, of the one or more publishers 106. Also as discussed previously, the computing device 110 receives the IP address for the content server 102 instead of the IP address for the specific publisher 106A. Once the computing device 110 receives the IP address for the content server 102, the end user 104 then utilizes the computing device 110 to send a request 166 for information content from the specific publisher 106A. Since the computing device 110 is in signal communication with the content server 102 and not the specific publisher 106A, the request 166 for information content is sent 800 to the content server 102 instead of the specific publisher 106A. Since the content server 102 does not generally have the requested information content from the specific publisher 106A, once the content server 102 receives the request 166 from the computing device 110, the content server 102 sends 802 a request 170 to the specific publisher 106A for the requested information content requested by the end user 104 utilizing the computing device 110. The specific publisher 106A receives the request 170 from the content server 102 and sends 804 the requested information content to the content server 102 as the second media data 172. The content server 102 receives the second media data 172 and detects any non-advertisement information content within the second media data 172 such as, for example, one or more non-advertisement information blocks or scripts. The content server 102 then modifies the second media data 172. In this step, the requested non-advertisement information content, within second media data 172 is modified by the content server 102. The modified second media data 172 that includes the modified non-advertisement information content is configured to be sent to the computing device 110 as the first media data 168. In this example, as part of the modification process performed by the content server 102, the content server 102 utilizes the rewrite engine 178 to rewrite the second media data 172 to remove any explicit references to non-advertisement information content and links and produce an execution code that is executable by the computing device 110. The execution code is included within the first media data 168 prior to sending the first media data 168 to the computing device 110. The content server 102 then connects with the information network 109 via signal path 124 and sends 806 a request 176 for the third media data 178 from the information network 109. The information network 109 receives the request 176 from the content server 102 and, in response, sends 808 the third media data 178 to the content server 102. The content server 102 receives the third media data 178 and modifies 608 the ad-related content of the third media data 178 that is related to non-advertisement information generation. The content server 102 then produces the first media data 168 from the modified second media data 172 and third media data 178. The content server 102 then sends 810 the first media data 168 to the computing device 110. As described earlier, the first media data 168 includes execution code(s) and the computing device 110 executes the execution code(s) to access the non-advertisement information, data, and/or content within the first media data 168 that is related to non-advertisement information generation.

The content server 102 is constructed and configured in a way to improve and optimize the delivery of non-advertisement information content to the computing device 110 and, as such, ultimately the end user 104. In general, the content server 102 acts as an intermediary between end users of computing devices and non-advertisement information generators (i.e., the entities producing the non-advertisement information at the information network 109), and applies multiple network and content optimization techniques to achieve reduced latency and improved efficiency while controlling delivered and shared information. The delivery mechanism ensures that only the information that is explicitly allowed by the one or more publishers 106 and/or the end user 104 of the computing device 110 is shared with the information network 109. In particular, the privacy of the end user 104 can be protected in a manner governed by the preferences of the one or more publisher 106 and/or end user 104 of the computing device 110. In addition, the adverse effect of ad blockers on the computing device 110 is eliminated by delivering all non-advertisement information through the content server 102 that is transparent to the ad blockers. Again, by utilizing the content server 102, non-advertisement information fraud is detected and curtailed by reducing the ability of malicious browser plug-ins and network bots to impersonate legitimate users or entities.

Similar to the last example, the content server 102 can reduce the lag time often associated with Internet non-advertisement information when the information network 109 is allowed to display non-advertisement information to an end user 104, of the computing device 110, as a third party. For example, while downloading a block or script of the information network 109, the browser of the computing device 110 might receive several redirects, JavaScript insertions and instructions to render more content from third and fourth party web servers that are part of a large information network 109. Once the final redirect or non-advertisement information image insertion is performed, the final resource, such as a non-advertisement information advertisement image, a flash block, or the like, is finally displayed in the appropriate position in browser widow 202 on the display 154 of the computing device 110 for presentation to the end user 104. These redirects can greatly slow the display process on the computing device 110.

Again, in this example, the content server 102 can act as a tunnel to the computing device 110 and ultimately the end user 104. The content server 102 can front-end all information network 109 entities (DSPs, DMPs, SSPs, publishers, etc.) to the computing device 110. The content server 102 can create a single, unique marker (cookie, supercookie, or the like) to track the computing device 110 while aliasing all third party trackers to this single marker. The content server 102 can keep a mapping of all third party trackers to this single marker and thereby transparently communicate on behalf of the end user 104 to these third-party systems.

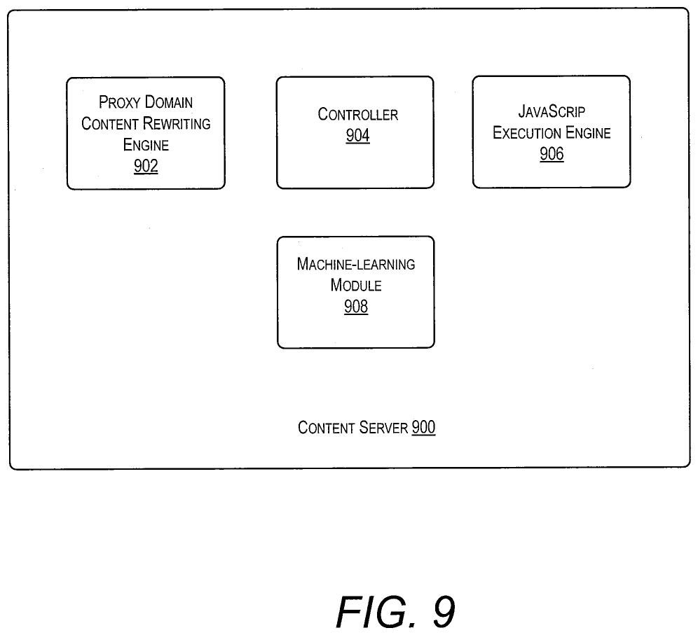

Turning to FIG. 9, a system block diagram of an example of another implementation of a content server 900 in accordance with the present disclosure. In this example, the content server 900 also includes one or more modules, such as a proxy domain content rewriting engine 902, a controller 904, a JavaScript execution engine 906, and a machine-learning module 908. The JavaScript execution engine 906 performs some or all tasks of executing JavaScript rather than having them all performed by the computing device 110, thus reducing processing and content access time to improve the performance of the computing device 110 and corresponding experience of the end user 104. The JavaScript execution engine 906 may also simultaneously perform advertising-related and non-advertisement information activities such as interactions with the third-party servers. The machine learning module 908 may be used to reduce the risk of errors in content rewriting and to predict interactions with third-party servers without the need to execute all scripts on the computing device 110. Additional similar modules could also be employed within the content server 900.

In this example, the proxy domain content rewriting engine 902 is a request/response processor and utilizes either the same domain as the original content or a special sub-domain for delivery of all advertising-related information. The proxy domain content rewriting engine 902 is resolved to the content server 900 to ensure privacy and security controls.

As an example, the content server 900 may replace all the inks to the advertising network 108 to point to a proxy domain and create a unique cookie/supercookie (UC) for tracking purposes. In this example, the content server 900 aliases the UC to all third-party trackers and the content server 900, where necessary, provides a JavaScript pass-through for third party domains but executes them on behalf of the third party domains. The content server 900, can use a JavaScript execution module (such as JavaScript execution engine 906) to minimize the repeated execution of the same/similar automatically or manually defined script fragments for a given publisher of the one or more publishers 106.

In this example, the controller 904 is a cloud-based policy enforcement engine that can control the exchanges of information between the computing device 110, the specific publisher 106A, and the advertising network 108. Per publisher of the one or more publishers 106 configuration and/or per computing device 110 of one or more computing devices configuration, the controller 904 maintains and enforces tracking and data exchange policies. The controller 904 manages publisher-defined allow/block preferences for third party trackers. The controller 904 also manages end user-defined allow/block preferences for third party trackers. For ease of the preference management of the end user 104, the controller 904 provides for default profiles typically derived from the publisher preferences. In addition, the content server 900 implements various techniques for reducing latency and improving bandwidth utilization. For example, the content server 900 may implement compression technologies, transmission control protocol (“TCP”) optimization, caching, and the like.

Turning back to FIGS. 1 through 8, the content server 102 can operate in various modes. For example, in full intercept mode, the computing device 110 interacts with all advertising networks (including advertising network 108) and/or non-advertising networks (including information network 109) through content server 102. In a hybrid or partial intercept mode, the computing device 110 interacts with one or more advertising networks 108 (including advertising network 108) and/or non-advertising networks (including information network 109) through the content server 102 and interacts with one or more selected advertising networks 108 and/or information network 109 directly. In yet another example, the content server 102 does not directly communicate with the advertising network 108 and/or information network 109. Sometimes, a specific publisher 106A will serve advertisements or non-advertisement information by itself without interacting with the advertising network 108 or information network 109. In this case, the content server 102 can still modify the advertising-related or non-advertisement information content through encryption, scrambling, and/or obfuscation of the advertising-related content and corresponding links in order to help optimize the display of the advertisements and/or bypass ad blockers.

In general, the content server 102 of the present invention offers several features and advantages over the convention advertising and non-advertisement information delivery systems. These features include use of control groups, ad fraud protection, multi-platform and multi-target implementations, ad preservation and avoiding ad blockers, selective rewriting, contextual advertisement matching, and techniques used to optimize an experience of an end user 104.

### Control Groups

The content server 102 enables publishers of the one or more publishers 106 to choose certain end users via their respective computing devices as control groups. This can be done to verify the efficacy and efficiency of the applied technologies and to provide a way to quantify the benefits of different variants of a solution. Such control groups can be defined based on geography (country, county, city, etc.), network/ISP, or by IP block lists. For control groups, the content server 102 will preserve the original advertising code/interactions and only gather information for monitoring purposes. The specific publisher 106A can maintain full control over the duration of the treatment of each control group by the content server 102. For example, the specific publisher 106A may keep a control group for three months and then initiate an application of the content server 102 thereafter to improve the user experience for the control group's members.

### Ad Fraud Protection

The content server 102 of the present disclosure provides a direct way to detect and help fight ad fraud due to the fact that the content server 102 screens and intercepts all ad-related interactions, the content server 102 can detect the presence of a malicious browser plug-in that inserts any foreign links. In addition, because the content server 102 proxies all legitimate advertising requests, the advertising network 108 can choose to block all requests coming from servers not associated with the content server 102, such as bots.

### Multi-Platform and Multi-Target Implementations

The content server 102 also lends itself to publisher's integration with multiple advertising platforms and targeting multiple audiences. The content server 102 has access to content and end user 104 information, and it implements adaptive rewriting algorithms. Therefore, the content server 102 can provide direct and efficient controls for the specific publisher 106A to specify the rules for inserting advertising code into its pages and selecting different code depending on the computing device 110 location and other characteristics of the publisher and advertiser choosing.

### Ad Preservation and Avoiding Ad Blockers

The content server 102 can detect the presence ad blockers and rewrite corresponding URLs to avoid blocking. The delivery of third-party advertisements are converted to a first-party by virtue of the content server 102 using the same domain or a sub-domain of the publishers' domain thus avoiding blocking by recognizing a well-known advertising domain and/or advertiser's IP address. Additionally, the ad-related URLs are obfuscated to avoid blocking by address part. For example, a rule that tries to find links such as/banner/*/img\hat{ } will fail because the rewritten URL's will look like L2Jhbm51ci9hZHZlcnRpc2VyL2ltZy9iYW5uZXluanBn. This example uses a base64 encoding of the path “/banner/advertiser/img/banner.jpg”. The content server 102 may use more secure methods, such as encryption, to make such obfuscation completely obscure to ad blockers.

### Selective Rewriting

The content server 102 can use a client-side JavaScript code to detect the presence of ad blockers by comparing the DOM elements with the original links. If such an ad blocker is detected, then all advertising content is forced through a publisher's domain, either a special domain or the same domain that is used for delivery of the base HTML. Additionally, the paths and file names are obfuscated in order to avoid blocking by a match to a certain string in URL, such as ads.js. If no ad blockers are detected then the specific publisher 106A can choose to allow some or all advertising links to be kept intact to reduce transmission costs and preserve the original protocol interactions. In combination with publisher/end user based preferences is a powerful mechanism to preserve ads.

### Logging Activity

The content server 102 may be configured to log any activity between the computing device 110, one or more publishers 106, advertising network 108, and information network 109. As part of the rewriting process described earlier between the computing device 110 and third party (i.e., the advertising network 108 and/or information network 109), the content server 102 is an intermediary between the computing device 110 and the advertising network 108 and/or information network 109 and is able to log and record events that would normally be visible to the primary application owner (i.e., the entity that would normally be directing communicating with the computing device 110). As such, the content server 102 has the visibility of the events between the computing device 110 and the advertising network 108 and/or information network 109 that are logged and recorded by the content server 102. This allows an audit trail to be created for what was delivered to the end user 104 of the computing device 110 through a record of the “chain” of events in the communication between the computing device 110 and the advertising network 108 and/or information network 109. This logging and recording is applicable to both advertising information and statistics and any non-advertising information such as financial transactions.

### Intelligent and Heuristics

As discussed earlier, the content server 102 can detect the presence ad blockers and rewrite corresponding URLs to avoid blocking. Additionally, the content server 102 may utilize “intelligent heuristics” to compare the “expected” transaction of the end user 104 of the computing device 110 versus the “actual” occurrence of the transaction.

As an example, without the content server 102, the end user 104 of the computing device 110 connects to web server that has HTML code that redirects the computing device 110 to a third party “information source” at the advertisement network 108. However, in this example, this HTML code does not execute in the browser that the end user 104 is using on the computing device 110 because of a “plugin in the browser” and/or design of the browser itself—for example browser blocking elements of within the browser. By utilizing the content server 102, the content server 102 acts as an “intermediary” between the web browser on the computing device 110 and the third party information source at the advertisement network 108. In this example, by acting as the intermediary, the content server 102 is able to: detect the presence of a piece of code that renders the webpage on the web browser of the computing device 110 differently than the original intent of the specific publisher 106A and/or advertising network 108; and enforce the delivery of the third party elements by incorporating (i.e., re-writing) the third party elements into other first party elements of the webpage originally produced by the specific publisher 106A that is presented to the computing device 110 via the content server 102.

In this example, the content server 102 not only utilizes this intelligence and heuristics to ad-blocking situations but also to situations where there is missing elements in information provided by either the advertising network 108 or information network 109. Additionally, the content server 102 utilizing this approach to detect potential insertion of additionally elements in the media data that is not “expected” such as, for example, situations where malware is potentially injected or where injection of an ID or authentication ID that attempts to “assume” the identity of another end user.

In these examples, the content server 102 may analyze any third party code on site (i.e., at the content server 102) to detect any issues. In general, these examples apply to something on the computing device 110 that would be interfering with delivery of third party information from either the advertising network 108 or information network 109. This example would include a situation where the third party JavaScript embedded on the desired website code was compromised. There are several methods to detect that include, for example, multi-stage redirects, GEO-redirect protection, black or whitelist domain approach to filtering third party requests, and third party redirects that must contain a “pre-approved” authentication trust element (i.e., some form of key that is passed and shared between authorized hosts).

In the case of multi-stage redirects, the content server 102 may prevent redirection beyond a first redirect.

As an example, a code executes a call for information to googleadserver.com to deliver an object. The expected response would naturally come back from googleadserver.com; however an additional redirect is issued to a non-googleadserver.com domain. This event could be detected by the content server 102 and based upon a pre-configured allowed number of redirects, the content server 102 can prevent or alert to their occurrence based upon count.

In the case of GEO-redirect protection, any redirection to third party outside of a “permitted” geo area (i.e., no redirection to certain countries) will be prevented by the content server 102.

The content server 102 can use a client-side JavaScript code to detect the presence of ad blockers by comparing the DOM elements with the original links. If such an ad blocker is detected, then all advertising content is forced through a publisher's domain, either a special domain or the same domain that is used for delivery of the base HTML. Additionally, the paths and file names are obfuscated in order to avoid blocking by a match to a certain string in URL, such as ads.js. If no ad blockers are detected then the specific publisher 106A can choose to allow some or all advertising links to be kept intact to reduce transmission costs and preserve the original protocol interactions. In combination with publisher/end user based preferences is a powerful mechanism to preserve ads.

### Contextual Advertisement Matching

Contextual advertising or context match refers to the placement of commercial advertisements within the content of a web page. The content server 102 provides means for contextual advertisement matching based on a combination of semantic and syntactic features. For example, the content server 102 inserts such information as keywords and page description and title into a custom HTTP header (or a set of headers) passed to the advertising networks on subsequent requests from the browser of the computing device 110. More advanced techniques of context analysis, application of various classification and categorization algorithms, natural language processing coupled with URL link analysis can potentially yield more in-depth information about the page and its relevance to various advertisements. By analyzing the text or image of the resulting ad, the content server 102 can provide the specific publisher 106A with an automated way of rejecting the advertisements that are not relevant to the displayed original content. For example, if there is a vocabulary mismatch between the page and the textual advertisement, then such advertisement can be rejected.

### Techniques Used to Optimize End User Experience

A first technique useful for improving or optimizing an experience of the end user 104 is network acceleration. Network acceleration eliminates the last mile to-and-from traffic by terminating third party trackers at the controller 704. Network acceleration also provides TCP-based optimizations (pacing, fast retransmits etc.) for last-mile traffic.

A second technique useful for improving or optimizing an experience of the end user 104 is content acceleration. Content can be accelerated by optimizing JavaScript execution and a combination of asynchronous and delayed execution. When the content server 102 determines that the original content includes synchronous JavaScript calls, the content server 102 converts them to asynchronous ones. Non-essential JavaScripts can be delayed and loaded into browsers while the computing device 110 is already accessing core content, thus significantly improving performance and perception of the quality of the site. Content can also be accelerated by websocket stream compression of all content including HTTP headers.

Another technique useful for improving or optimizing an experience of the end user 104 is publisher content and advertisement security. The content server 102 enables improved HTTPS based services to computing devices of end users in all cases where such services were not implemented or caused additional latency. The HTTPS connections are terminated at proxy (end user to proxy; proxy to publisher; proxy to advertising ecosystem where feasible). The content server 102 also enables advertisements and trackers with HTTPS content whenever such advertisements were not delivered via the TLS secure protocol. Such TLS termination has additional benefits, such as reducing latency by eliminating all TLS handshakes except one for the main domain and offloading challenging tasks of establishing TLS connections.

The content server 102 also provides improved privacy protection. Based on preferences of the end users and publishers, the content server 102 provides configurable options for choosing proper tracking preferences. The specific publisher 106A can control which information about end users is shared with advertisers and their agents, and an end user 104 has access to setting up such preferences in the displayed ads.

As an additional and optional service, the content server 102 has a dedicated online site for an end user 104 to specify what information they are willing to share with advertisers employed by the publishers that are using the content server 102 and which content they prefer to see as advertisements on the corresponding sites and applications. Such centralized way of submitting end user 104 preferences benefits both the end user 104, who needs to do it once and be protected until they change their preferences, and to the content server 102 itself which now has a direct way of monetizing the available information with the consent of the end user 104. In addition, the content server 102 can use such prepared information to satisfy requirements of the advertising network 108 without additional interactions with the computing device 110 of the end user 104.

The content server 102 may also implement header bidding in an effort to maximize revenues for a specific publisher 106A. The header bidding enables multi-platform advertising exchanges and/or SSPs to bid for specific inventory in a page and selects the highest yield advertisements per publishers' policies. It avoids/offsets the overhead the computing device 110 of the end user 104 has to incur in implementing header bidding.

The content server 102 enables targeting and retargeting. The content server 102 can learn end user 104 preferences and provides this as additional information to advertising networks 108 for better targeting and retargeting. This also helps avoid annoying, irrelevant advertisements to be displayed on the computing device 110 to the end user 104. Thus, the content server 102 provides a way of communicating with a specific publisher 106A, such as a publisher server, and a method of transforming Internet content received from the specific publisher 106A. The method includes the steps of receiving a request from at least one end user 104 for the main content residing on the specific publisher 106A server, the content including and referencing additional content residing on at least one server other than the specific publisher 106A server; modifying, such as by rewriting, the main content and inserting special instructions for processing on the computing device 110, such as an end user execution code; and transmitting the rewritten content including the special transformation instructions to be performed by the end user 104 on the computing device 110. The transformation on the content server 102 results in (i) some or all external content links being modified or rewritten so that they are served from the same domain as the main content, (ii) some external content links being rewritten so that they are served from a different domain but still under the control of the owner of the main content, (iii) some or all external content links being rewritten so that they are served from the same domain as the main content, and/or (iv) some external content links being rewritten so that they are served from a different domain but still under the control of the owner of the main content. The transformation may result in variants of (i) to (iv) with at least some parts of the links being modified so they are obfuscated or encrypted and prevent recognition of their purpose, such as by an ad blocker.

The content server 102 also provides a way of communicating with a specific publisher 106A, such as a publisher server, a method of transforming Internet content received from the publisher server including receiving a request from at least one end user 104 for the main content residing on the publisher server, the content including additional content, such as content related to advertising generation; modifying, such as by rewriting, the main content and inserting special instructions for processing on the client, such as an end user execution code; and transmitting the modified or rewritten content including the special transformation instructions to be performed by the end user. The transformation on the content server 102 results in (i) all or some additional content being rewritten so that it is indistinguishable from the main content and not detectable by an ad blocker, for example by application of a keyword matching algorithm or by any other means such as a regular expression searches for a particular set of characters or a combination of characters and/or (ii) all or some additional content being rewritten so that it is indistinguishable from the main content and not detectable by an ad blocker, for example by application of a keyword matching algorithm or by any other means such as a regular expression searches for a particular set of characters or a combination of characters. The transformation can result in a variant of (i) and (ii) where the rewriting involves some known methods of modification by obfuscation or encryption. The proxy can employ various methods of speeding up interactions with the clients and third-party servers such as SSL offload, pre-loading of links and DNS prefetching, re-use and multiplexing connections and requests. The content server 102 can do third-party cookie handling on behalf of the end user 104. The proxied requests to the third-party servers may contain contextual and semantic information about the main content. The content server 102 can analyze the responses containing the third-party content and apply pre-set filtering rules according to the publisher's policies such as filtering by domain name, filtering by keywords and context, filtering using image and video frames recognition, filtering based on content and advertising efficacy and performance transformation rules, and anonymizing client's IP address and other privacy data thus implementing compliance to various privacy regulations.

The content server 102 can also provide a manner for complete reporting on viewability of all elements of a webpage including advertising content as well as the click history of clickable links on the page, script insertion to peer into viewability of page elements, and coalescing and aggregating viewability elements by the proxy at a page and site level. Viewability metrics can be gathered on a per element basis, for example iframe which has an advertising creative. These can be coalesced to gather a per page viewability metric while aggregated to get statistics at a page, site, third-party, etc. levels. predictive viewability metrics can be established and communicated to third-parties for optimizing advertisement selection.

The disclosure presented herein may be considered in view of the following example clauses.

Example Clause A, a content server for managing media data between one or more publishers, an advertising network, and a computing device, the content server comprising: one or more processing units; computer-readable media storing instructions that, when executed by the one or more processing units, cause the content server to perform operations comprising: receiving, as an intermediary, a request from the computing device for information content from a specific publisher of the one or more publishers; requesting the information content from the specific publisher, wherein the information content includes advertising-related content; receiving, from the specific publisher, the information content within a first media data; detecting the advertising-related content within the information content; modifying the advertising-related content to produce a modified information content; producing and inserting an execution code into the modified information content to produce a second media data; serving the second media data to the computing device; receiving from the computing device a request for the advertising-related content; requesting the advertising-related content from the advertising network; receiving the advertising-related content from the advertising network; modifying the advertising-related content to produce a modified advertising-related content; inserting the modified advertising-related content into second media data to produce an updated second media data; and serving the updated second media data to the computing device in a manner where it may be accessed by the computing device when the execution code is invoked by an end user of the computing device.

Example Clause B, the content server of clause A, where the first media data corresponds to the second media data 172, second media data corresponds to the first media data 168, advertising-related content corresponds to the third media data 178, and updated second media data also corresponds to the first media data 168.

Example Clause C, a method for managing internet advertising content, the method comprising: receiving as an intermediary a request from an end user for Internet content from a publisher; making a request to the publisher and receiving Internet content from the publisher, the Internet content including advertising-related content; modifying the advertising-related content; inserting into the Internet content an execution code; serving the Internet content including the modified advertising-related content and the execution code to the end user; receiving from the end user a request for advertising-related content; requesting advertising-related content from an advertising network and receiving the advertising-related content; modifying the advertising-related content received from the advertising network; and serving the modified advertising-related content to the end user in a manner where it may be accessed by the end user when the execution code is invoked by the end user.

Example Clause D, the method of clause C, wherein the modifications to the Internet content and the advertising-related content result in the Internet content and the advertising-related content being accessed by the end user with reduced latency than if the modifications had not been made.

Example Clause E, the method of clause C, wherein the modifications to the advertising-related content make the advertising-related content less recognizable to an ad blocker than if the modifications had not been made.

Example Clause F, the method of clause C, wherein the modified advertising-related content is displayed by the end user when the execution code is invoked by the end user.

Example Clause G, the method of clause C, wherein the advertising-related content received from the publisher is an advertisement block.

Example Clause H, the method of clause C, wherein the advertising-related content received from the advertising network is an advertisement.

Example Clause I, the method of clause C, further comprising performing a fraud check on the advertising-related content before it is served to the end user.

Example Clause J, a system for managing internet advertising content, the system comprising: a proxy server intermediary to an end user, a publisher of Internet content, and an advertising network, wherein the publisher and the advertising network can communicate indirectly with the end user through the proxy server, wherein the proxy server: receives Internet content from the publisher, detects advertising-related content in the Internet content, modifies the advertising-related content, inserts an execution code into the Internet content, serves the Internet content to the end user, receives from the end user a request for advertising-related content, requests and receives advertising-related content from an advertising network, modifies the advertising-related content from the advertising network; and serves the advertising-related content to the end user, whereby the end user may access the advertising-related content when the execution code is invoked by the end user.

Example Clause K, the system of clause J, wherein the proxy server is a cloud proxy or cloud network made up of one or more servers.

Example Clause L, the system of clause J, wherein the advertising network comprises one or more servers used to select advertisements and/or produce an advertising-related resource.

Example Clause M, the system of clause J, wherein the advertising-related content from the publisher is an advertising block or script.

Example Clause N, the system of clause J, wherein the advertising-related content from the advertising network is an advertisement.

Example Clause O, the system of clause J, wherein the end user is a program that allows an individual to interact with Internet content.

Example Clause P, the system of clause O, wherein the program is an Internet browser that displays internet information on a screen.

Example Clause Q, the system of clause J, wherein the publisher and the advertising network communicate with the end user only through the proxy server.

Example Clause R, the system of clause J, wherein the proxy server ensures that only pre-approved advertising-related content can be delivered to the end user and no third-party code can be delivered.

Example Clause S, the system of clause J, wherein the modified Internet content served to the end user has reduced latency than if the Internet content from the publisher and the advertising-related content were delivered to the end user without being modified.

Example Clause T, the system of clause J, wherein the modified advertising-related content is less recognizable to an ad blocker than if the modifications had not been made.

Example Clause U, the system of clause J, wherein the proxy server performs a fraud check on the advertising-related content before serving the advertising-related content to the end user.

Example Clause V, the system of clause J, wherein the proxy server can operate in one or more modes, wherein the modes comprise a full intercept mode where the end user interacts with all advertising networks through the proxy server and a partial intercept mode where the end user interacts with an advertising network through the proxy server and with an advertising network directly.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Moreover, the operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A content server for managing media data between one or more publishers, an information network, and a computing device, the content server comprising:
one or more processing units;
computer-readable media storing instructions that, when executed by the one or more processing units, cause the content server to perform operations comprising:
receiving, as an intermediary, a request from the computing device for information content from a specific publisher of the one or more publishers;
requesting the information content from the specific publisher, wherein the information content includes non-advertisement information content;
receiving, from the specific publisher, the information content within a first media data;
detecting the non-advertisement information content within the information content;
modifying the non-advertisement information content to produce a modified information content;
producing and inserting an execution code into the modified information content to produce a second media data;
serving the second media data to the computing device;
receiving from the computing device a request for the non-advertisement information content;
requesting the non-advertisement information content from the information network;
receiving the non-advertisement information content from the information network;
modifying the non-advertisement information content to produce a modified non-advertisement information content;
inserting the modified non-advertisement information content into second media data to produce an updated second media data; and
serving the updated second media data to the computing device in a manner where it may be accessed by the computing device when the execution code is invoked by the computing device.

2. The content server of claim 1, wherein modifying the non-advertisement information content to produce a modified information content includes modifying the non-advertisement information content to be less recognizable to an ad blocker.

3. The content server of claim 1, wherein the execution code is invoked by an end user of the computing device

4. The content server of claim 1, wherein modifying the non-advertisement information content to produce a modified information content includes modifying the non-advertisement information content to be reduce latency at the computing device.

5. The content server of claim 1, wherein the non-advertisement information content received from the specific publisher is a non-advertisement block.

6. The content server of claim 1, wherein the non-advertisement information content received from the information network is financial information.

7. The content server of claim 1, wherein the content server further performs a fraud check on the non-advertisement information content before it is served to the computing device.

8. A method for managing media data between one or more publishers, an information network, and a computing device with a content server, the method comprising:
receiving, as an intermediary, a request from the computing device for information content from a specific publisher of the one or more publishers;
requesting the information content from the specific publisher, wherein the information content includes non-advertisement information content;
receiving, from the specific publisher, the information content within a first media data;
detecting the non-advertisement information content within the information content;
modifying the non-advertisement information content to produce a modified information content;
producing and inserting an execution code into the modified information content to produce a second media data;
serving the second media data to the computing device;
receiving from the computing device a request for the non-advertisement information content;
requesting the non-advertisement information content from the information network;
receiving the non-advertisement information content from the information network;
modifying the non-advertisement information content to produce a modified non-advertisement information content;
inserting the modified non-advertisement information content into second media data to produce an updated second media data; and
serving the updated second media data to the computing device in a manner where it may be accessed by the computing device when the execution code is invoked by the computing device.

9. The method of claim 8, wherein modifying the non-advertisement information content to produce a modified information content includes modifying the non-advertisement information content to be less recognizable to an ad blocker.

10. The method of claim 8, wherein the execution code is invoked by an end user of the computing device

11. The method of claim 8, wherein modifying the non-advertisement information content to produce a modified information content includes modifying the non-advertisement information content to be reduce latency at the computing device.

12. The method of claim 8, wherein the non-advertisement information content received from the specific publisher is a non-advertisement block.

13. The method of claim 8, wherein the non-advertisement information content received from the information network is financial information.
